(19) United States
(12) Patent Application Publication
(10) Pub. No.: US 2026/0301316 A1
(43) Pub. Date: Oct. 1, 2026

(54) THREE-DIMENSIONAL MODEL GENERATION DEVICE, THREE-DIMENSIONAL MODEL GENERATION SYSTEM, AND OPERATION METHOD OF THREE-DIMENSIONAL MODEL GENERATION SYSTEM

(71) Applicant: FUJIFILM Corporation, Tokyo (JP)

(72) Inventors: Koichi TANAKA, Saitama-shi (JP); Toshiki KOBAYASHI, Saitama-shi (JP); Shinichi FUJIMOTO, Saitama-shi (JP); Mamiko SATO, Saitama-shi (JP)

(73) Assignee: FUJIFILM Corporation, Tokyo (JP)

(21) Appl. No.: 19/629,363

(22) Filed: Mar. 26, 2026

(30) Foreign Application Priority Data
Mar. 28, 2025 (JP) 2025-056484

(51) Int. Cl. G06T 17/00; G06T 3/40; G06T 15/04

(52) U.S. Cl. CPC G06T 17/00; G06T 3/40; G06T 15/04; G06T 2210/36

(57) ABSTRACT

A three-dimensional model generation device according to one aspect of the present invention includes a processor, in which the processor is configured to acquire a plurality of first images having a first resolution with respect to a plurality of first directions of an object, acquire a plurality of second images having a second resolution lower than the first resolution with respect to a plurality of second directions of the object, generate three-dimensional shape information of the object by using the plurality of second images, generate surface information of the object corresponding to the three-dimensional shape information by using the plurality of first images, and generate a three-dimensional model of the object by mapping the surface information onto a three-dimensional shape indicated by the three-dimensional shape information.

### CROSS-REFERENCE TO RELATED APPLICATION

The present application claims priority under 35 U.S.C § 119(a) to Japanese Patent Application No. 2025-056484 filed on Mar. 28, 2025, which is hereby expressly incorporated by reference, in its entirety, into the present application.

### BACKGROUND OF THE INVENTION

### 1. Field of the Invention

The present invention relates to a three-dimensional model generation device, a three-dimensional model generation system, and an operation method of a three-dimensional model generation system.

### 2. Description of the Related Art

Regarding generation of a composite image, for example, JP2014-238299A discloses a technology of calculating shape information of a subject by using two-dimensional data having a high resolution and three-dimensional data having a low resolution.

### SUMMARY OF THE INVENTION

One embodiment according to the technology of the present disclosure provides a three-dimensional model generation device, a three-dimensional model generation system, and an operation method of a three-dimensional model generation system.

According to a first aspect of the present invention, there is provided a three-dimensional model generation device comprising: a processor, in which the processor is configured to acquire a plurality of first images having a first resolution with respect to a plurality of first directions of an object, acquire a plurality of second images having a second resolution lower than the first resolution with respect to a plurality of second directions of the object, generate three-dimensional shape information of the object by using the plurality of second images, generate surface information of the object corresponding to the three-dimensional shape information by using the plurality of first images, and generate a three-dimensional model of the object by mapping the surface information onto a three-dimensional shape indicated by the three-dimensional shape information.

According to a second aspect of the present invention, in the three-dimensional model generation device according to the first aspect, the processor is configured to generate and acquire the plurality of second images by subjecting the plurality of first images to low-resolution processing.

According to a third aspect of the present invention, in the three-dimensional model generation device according to the second aspect, the processor is configured to determine a degree of the low-resolution processing depending on complexity of the three-dimensional shape of the object, and perform the low-resolution processing at the determined degree.

According to a fourth aspect of the present invention, in the three-dimensional model generation device according to the third aspect, the processor is configured to lower the degree of the low-resolution processing as the complexity increases.

According to a fifth aspect of the present invention, in the three-dimensional model generation device according to the third or fourth aspect, the processor is configured to calculate the complexity based on object information that is information on the object.

According to a sixth aspect of the present invention, in the three-dimensional model generation device according to any one of the third to fifth aspects, the processor is configured to calculate the complexity by analyzing the plurality of first images, and determine the degree according to the calculated complexity.

According to a seventh aspect of the present invention, in the three-dimensional model generation device according to any one of the third to sixth aspects, the processor is configured to perform feature amount extraction processing on at least a region in which the object is present in the plurality of first images, and calculate the complexity based on a feature amount obtained by the feature amount extraction processing.

According to an eighth aspect of the present invention, in the three-dimensional model generation device according to the seventh aspect, the processor is configured to calculate the complexity by using, as the feature amount, an edge degree obtained by edge detection in the region.

According to a ninth aspect of the present invention, in the three-dimensional model generation device according to any one of the third to eighth aspects, the processor is configured to acquire a plurality of polarized images obtained by imaging the object in a plurality of polarization states in which polarization directions are different, acquire reflection information regarding reflection of the object based on the plurality of polarized images, and calculate the complexity based on the reflection information.

According to a tenth aspect of the present invention, in the three-dimensional model generation device according to the ninth aspect, the processor is configured to acquire, as the plurality of polarized images, a plurality of polarized images obtained by imaging the object in a plurality of polarization states in which first polarization directions determined by rotation angles of a first polarizer provided in an illumination device are different.

According to an eleventh aspect of the present invention, in the three-dimensional model generation device according to the ninth or tenth aspect, the processor is configured to acquire, as the plurality of polarized images, a plurality of polarized images obtained by imaging the object in a plurality of polarization states in which second polarization directions determined by rotation angles of a second polarizer provided in an imaging device are different.

According to a twelfth aspect of the present invention, in the three-dimensional model generation device according to any one of the third to eighth aspects, the processor is configured to acquire a plurality of polarized images obtained by imaging the object in a plurality of polarization states in which polarization directions are different, acquire intersection direction information regarding a direction intersecting a surface of the object based on the plurality of polarized images, and calculate the complexity based on the intersection direction information.

According to a thirteenth aspect of the present invention, in the three-dimensional model generation device according to the twelfth aspect, the processor is configured to acquire, as the plurality of polarized images, a plurality of images obtained by imaging the object in a plurality of polarization states in which first polarization directions determined by rotation angles of a first polarizer provided in an illumination device are different.

According to a fourteenth aspect of the present invention, in the three-dimensional model generation device according to the twelfth or thirteenth aspect, the processor is configured to acquire, as the plurality of polarized images, a plurality of images obtained by imaging the object in a plurality of polarization states in which second polarization directions determined by rotation angles of a second polarizer provided in an imaging device are different.

According to a fifteenth aspect of the present invention, in the three-dimensional model generation device according to any one of the third to fourteenth aspects, the processor is configured to acquire distance information for the object associated with the plurality of first images, and calculate the complexity based on the distance information.

According to a sixteenth aspect of the present invention, in the three-dimensional model generation device according to any one of the first to fourteenth aspects, the processor is configured to receive input of complexity information indicating complexity of the three-dimensional shape of the object from a user, and determine the second resolution based on the complexity information.

According to a seventeenth aspect of the present invention, in the three-dimensional model generation device according to any one of the first to sixteenth aspects, the processor is configured to acquire, as the plurality of second images, a plurality of images obtained by imaging different from imaging for acquiring the plurality of first images.

According to an eighteenth aspect of the present invention, in the three-dimensional model generation device according to any one of the first to seventeenth aspects, the surface information includes at least information on a base color of the object.

According to a nineteenth aspect of the present invention, in the three-dimensional model generation device according to the eighteenth aspect, the surface information further includes information on at least one of a metalness or a roughness.

According to a twentieth aspect of the present invention, in the three-dimensional model generation device according to any one of the first to nineteenth aspects, the processor is configured to generate the three-dimensional shape information by using any one of generators constructed using photogrammetry, time of flight, and machine learning methods.

According to a twenty-first aspect of the present invention, there is provided a three-dimensional model generation system comprising: the three-dimensional model generation device according to any one of the first to twentieth aspects; and an imaging device that images the object to acquire the plurality of first images.

According to a twenty-second aspect of the present invention, in the three-dimensional model generation system according to the twenty-first aspect, the imaging device is capable of acquiring a plurality of images having different polarization directions as the plurality of first images and/or the plurality of second images.

According to a twenty-third aspect of the present invention, the three-dimensional model generation system according to the twenty-first or twenty-second aspect further comprises: an illumination device that is capable of emitting illumination light beams having different polarization directions, in which the imaging device images the object irradiated with the illumination light beams having different polarization directions to acquire the plurality of first images and/or the plurality of second images.

According to a twenty-fourth aspect of the present invention, there is provided an operation method of a three-dimensional model generation device including a processor, the operation method comprising: causing the processor to execute acquiring a plurality of first images having a first resolution with respect to a plurality of first directions of an object, acquiring a plurality of second images having a second resolution lower than the first resolution with respect to a plurality of second directions of the object, generating three-dimensional shape information of the object by using the plurality of second images, generating surface information of the object corresponding to the three-dimensional shape information by using the plurality of first images, and generating a three-dimensional model of the object by mapping the surface information onto a three-dimensional shape indicated by the three-dimensional shape information.

The operation method according to the twenty-fourth aspect may have the same configuration as the second to twentieth aspects. In addition, a program causing a computer to execute the operation method of each of the above-described aspects, and a non-transitory tangible recording medium on which a computer-readable code of such a program is recorded can also be exemplified as one aspect of the present invention.

### BRIEF DESCRIPTION OF THE DRAWINGS

FIG. 1 is a diagram showing an overall configuration of a three-dimensional model generation system according to a first embodiment.

FIG. 2 is a diagram showing a configuration of a three-dimensional model generation device.

FIG. 3 is a diagram showing a functional configuration of a processor.

FIG. 4 is a diagram showing information recorded in a recording device.

FIG. 5 is a diagram showing a configuration of an imaging system.

FIG. 6 is a diagram showing an overall flow of three-dimensional model generation.

FIG. 7 is a diagram showing an example of multi-view images.

FIGS. 8A and 8B are diagrams showing how complexity of a three-dimensional shape is determined.

FIGS. 9A and 9B are diagrams showing how an image is subjected to low-resolution processing.

FIG. 10 is a diagram showing how a texture is mapped onto a three-dimensional shape.

FIG. 11 is a diagram showing a modification example of the imaging system.

FIG. 12 is a diagram showing a modification example of the overall flow.

FIG. 13 is a diagram showing an overall flow of processing in a second embodiment.

### DESCRIPTION OF THE PREFERRED EMBODIMENTS

### Resolution of Image Used for Generation of Three-Dimensional Model

In recent years, a technology of generating a three-dimensional model of an object by using an image of the object has been developed. Elements of the three-dimensional model are a shape (polygon, mesh, surface, and the like) and a texture, but the texture has a large effect on the quality (visual resolution) of the three-dimensional model. Therefore, in order to improve the quality of the texture, it is necessary to increase a resolution of an image to be input, but increasing the resolution increases a calculation time. In view of such circumstances, the inventors of the present application have made intensive studies and have obtained a finding that “in generating the three-dimensional model, by using an image having a high resolution for texture generation and using an image having a lower resolution than that used for the texture generation for shape data generation, it is possible to reduce a processing load while maintaining the quality of the three-dimensional data”. The present invention has been created based on such a finding, and preferred embodiments of a three-dimensional model generation device, a three-dimensional model generation system, and an operation method of a three-dimensional model generation system according to the embodiments of the present invention will be described below with reference to the accompanying drawings.

In the drawings below, in order to facilitate the description, some members may be omitted. In addition, the drawings do not necessarily accurately show the shape and dimensions of each member.

### First Embodiment

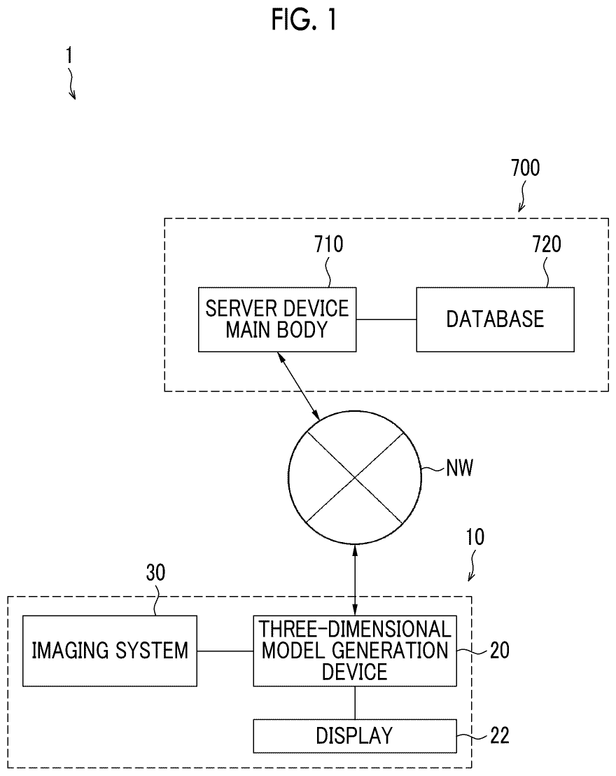

FIG. 1 is a diagram showing a configuration of a system 1 according to a first embodiment. The system 1 comprises a three-dimensional model generation system 10 (three-dimensional model generation system) and a server device 700, which are connected via a network NW. The three-dimensional model generation system 10 comprises a three-dimensional model generation device 20 (three-dimensional model generation device), a display 22 (output device, display device), and an imaging system 30. The three-dimensional model generation device 20 and the imaging system 30 may be directly connected, or may be connected via a network such as the network NW. The server device 700 comprises a server device main body 710 and a database 720.

### Configuration of Three-Dimensional Model Generation System

### Configuration of Three-Dimensional Model Generation Device

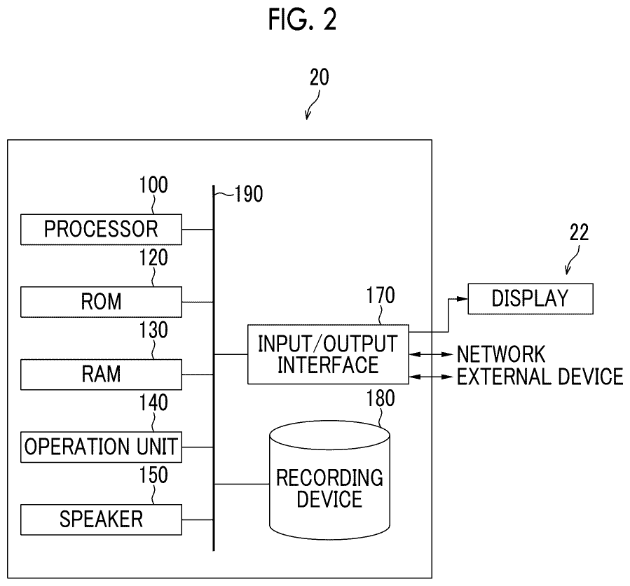

FIG. 2 is a diagram showing a configuration of the three-dimensional model generation device 20. The three-dimensional model generation device 20 comprises a processor 100 (processor), a read only memory (ROM) 120 (non-transitory tangible recording medium), a random access memory (RAM) 130, an operation unit 140, a speaker 150 (output device), an input/output interface 170, and a recording device 180 (output device), in which these components are connected by a bus 190. The three-dimensional model generation device 20 can communicate with the display 22 (output device, display device) and various external devices (server device, database, and the like) via the input/output interface 170, and as necessary, via a network. A device such as the display 22, the speaker 150, and the recording device 180 may be a component of the three-dimensional model generation device 20 or may be a type of the external device.

These elements of the three-dimensional model generation device 20 may be housed in a single housing or may be housed in a plurality of housings. The plurality of housings may be installed in separate locations (rooms, buildings, and the like).

### Functional Configuration of Processor

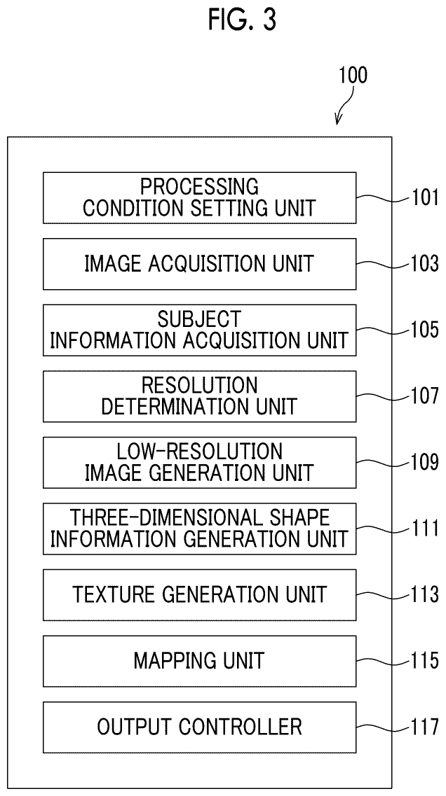

FIG. 3 is a diagram showing a configuration of functions of the processor 100 (processor). As shown in FIG. 3, the processor 100 includes a processing condition setting unit 101, an image acquisition unit 103, a subject information acquisition unit 105, a resolution determination unit 107, a low-resolution image generation unit 109, a three-dimensional shape information generation unit 111, a texture generation unit 113, a mapping unit 115, and an output controller 117.

### Overview of Functions of Processor

The processing condition setting unit 101 sets a condition related to generation, display, recording, and the like of a three-dimensional model in response to an operation of a user or automatically without the operation of the user. The image acquisition unit 103 acquires an image of an object (subject to be generated as a three-dimensional model) from the imaging system 30 or from a recording medium such as the database 720 (including having the imaging system 30 capture an image of the object and acquiring the image). The subject information acquisition unit 105 acquires information (subject information, object information) corresponding to complexity of a three-dimensional shape of a subject (object for which a three-dimensional model is generated). The resolution determination unit 107 determines a resolution or the like (the number of pixels or an image size, or a resize ratio with respect to an input image) of image data used to generate a mesh (three-dimensional shape information) based on the subject information. The low-resolution image generation unit 109 generates an image (a plurality of second images) having the determined resolution or the like based on an original image (a plurality of first images) of the object. The three-dimensional shape information generation unit 111 generates three-dimensional shape data from the low-resolution images (the plurality of second images). The generation of the three-dimensional shape data may include estimation of a position and an orientation of a camera, point cloud generation, and mesh generation. The texture generation unit 113 generates a texture to be mapped onto a three-dimensional shape from the original image of the object. The mapping unit 115 maps the texture onto the three-dimensional shape. The output controller 117 displays the processing condition, the image, the three-dimensional model, and the like on the display 22 (display device) and/or records the processing condition, the image, the three-dimensional model, and the like in an external recording device such as the recording device 180 (recording device) or the database 720. Details of a process performed by each of these units will be described below.

In the present embodiment, the process performed by each unit of the processor 100 can be executed by any computer. In addition, any computer may execute these processes using a processor as hardware, a program as software, or a combination thereof. In that case, the processor as hardware is configured to execute various processes in the present embodiment in cooperation with the program and can function as each unit or each means in the present embodiment. In addition, the execution order of the process by the processor is not limited to the order described above and may be changed as appropriate. Any computer may be a general-purpose computer, a computer for a specific use, a workstation, or another system capable of executing each process.

The processor 100 can be configured by using one or more pieces of hardware, and the type of the hardware is not limited. For example, the processor 100 can be configured with a central processing unit (CPU), a micro processing unit (MPU), a programmable logic device such as a field programmable gate array (FPGA), a dedicated circuit for executing a specific process such as an application specific integrated circuit (ASIC), or hardware such as a graphics processing unit (GPU) or a neural processing unit (NPU). In addition, the processor 100 has each unit or each means that executes various types of processes in the present embodiment. In addition, the types of hardware may be a combination of different types of hardware. In a case where a plurality of pieces of hardware are configured to execute one or a plurality of processes of a certain processor, the plurality of pieces of hardware may be present in devices physically separated from each other, or may be present in the same device. In addition, in any of the embodiments, the order of each process executed by the processor is not particularly limited and may be changed as appropriate. The hardware is configured by an electric circuit (circuitry) in which circuit elements such as semiconductor elements are combined.

Further, in the present embodiment, the processor 100 may be realized by hardware, software, firmware, microcode, or a combination thereof. Software, firmware, and microcode are configured by a program. In addition, the program may be, for example, a program module group, and each function thereof may be realized by a processor configured to execute each function. The program may be a program code or a plurality of code segments stored in one or a plurality of non-transitory tangible computer-readable media (for example, a storage medium or other storage; may be the ROM 120 or the recording device 180 (the same applies hereinafter)). The program may be divided and stored in a plurality of non-transitory tangible computer-readable media present in devices physically separated from each other. The program code or the code segment may represent any combination of a procedure, a function, a subprogram, a routine, a subroutine, a module, a software package, a class, an instruction, a data structure, or a program statement. The program code or the code segment may be connected to another code segment or a hardware circuit by transmitting and receiving information, data, an argument, a parameter, or memory contents.

In the present embodiment, the “non-transitory tangible computer-readable medium” does not include a non-tangible recording medium such as a carrier wave signal or a propagation signal itself. In a case of processing using the program, the processor 100 can use the RAM 130 as a temporary storage area or a work area.

### Configuration of Operation Unit and Display

The operation unit 140 is configured by a device such as a keyboard, a mouse, a button, and a switch (not shown). The user can issue an instruction to the three-dimensional model generation device 20 via these devices, and the processor 100 receives the instruction and performs processing in response to the received instruction. The display 22 may be configured by a touch panel device so that the user can issue the instruction through the touch panel. The display 22 is configured by such a touch panel device or a device such as a liquid crystal display device, and can display an image of the object, conditions for capturing an image (which may include information on exposure, shutter speed, sensitivity, camera position and/or orientation), information on the object (such as shape complexity), conditions and results of generating a three-dimensional model, and the like. In addition, the display 22 can display information recorded in the recording device 180. In addition to or instead of the display 22, another display (display device) may be connected via the input/output interface 170 and may be used for displaying various types of information.

### Configuration of Input/Output Interface

The input/output interface 170 is configured by a terminal or a slot for connecting an external device such as a display, a printer, or a recording medium, a communication interface such as Wi-Fi (registered trademark) or Bluetooth (registered trademark), and the like. The three-dimensional model generation device 20 can acquire data, such as an image of the object and conditions for capturing an image, from an external device (server device, recording device, database, and the like) via the input/output interface 170. The external device may be connected to the three-dimensional model generation device 20 by wire or wirelessly. In addition, the external device may be connected via the Internet, the cloud, or the like. In addition, an external device such as a 3D printer may be connected to the three-dimensional model generation device 20 so that the generated three-dimensional model can actually be output.

### Configuration of Recording Device

The recording device 180 (recording device, output device) is configured by a hard disk, a semiconductor memory such as a solid-state drive (SSD), a recording medium (non-transitory tangible computer-readable medium) such as various magneto-optical recording media, and a controller thereof, and records or stores various types of information.

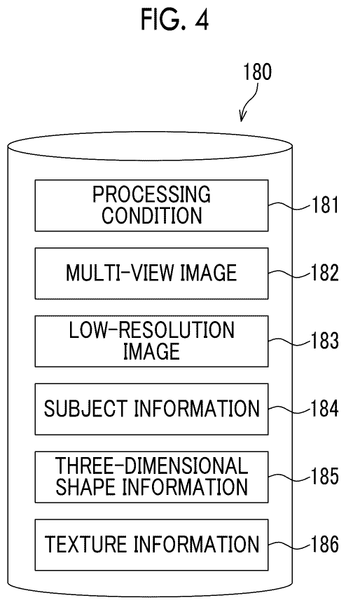

FIG. 4 is a diagram showing an example of the information recorded in the recording device 180. As shown in FIG. 4, the recording device 180 can record a processing condition 181, multi-view images 182, low-resolution images 183, subject information 184 (a feature amount of the subject and the like; object information), three-dimensional shape information 185 (three-dimensional shape information), and texture information 186 (surface information).

The processing condition 181 may include conditions for generating a three-dimensional model and conditions for capturing an image. The multi-view images 182 are a plurality of images (a plurality of first images) obtained by imaging the object from a plurality of first directions at a first resolution. The low-resolution images 183 are a plurality of images (a plurality of second images) corresponding to an image obtained by imaging the object from a plurality of second directions at a second resolution lower than the first resolution. As will be described in detail below, the low-resolution image 183 may be an image obtained by subjecting the multi-view image 182 to low-resolution processing, or may be an image obtained by imaging (separate imaging) different from imaging for acquiring the multi-view image 182. In addition, as will be described below in the section of “Configuration of Imaging System”, the multi-view image 182 and the low-resolution image 183 may be images captured while changing polarization directions of an illumination device and a camera. The subject information 184 (object information) may include a feature amount obtained by performing feature amount extraction processing on the subject or information on complexity of the three-dimensional shape of the subject calculated based on the feature amount.

The three-dimensional shape information 185 (three-dimensional shape information) may be polygons, a mesh that is a collection of polygons, or a surface. The texture information 186 (surface information) is information on a texture to be mapped onto the three-dimensional shape, and includes at least information on a base color. The texture information 186 may further include information on at least one of a metalness or a roughness.

It is preferable that these pieces of information be recorded in association with each other. In a case of associating the three-dimensional shape with the texture information, for example, a general-purpose three-dimensional file format such as GL Transmission Format (glTF) or OBJ can be used. In addition, in a case of associating the imaging conditions with image files, examples thereof include: incorporating, into a file name of corresponding information or a part thereof, characters and/or numbers common to the corresponding information; storing the corresponding information in the same folder; recording information on the imaging conditions in a header of an image; and separately recording, in a tabular form, an association between an image file and a file of the imaging conditions; however, the present disclosure is not limited to these examples. In addition, these pieces of information can be displayed on a display device such as the display 22 in response to an operation of the user or automatically without the operation.

### Configuration of Imaging System

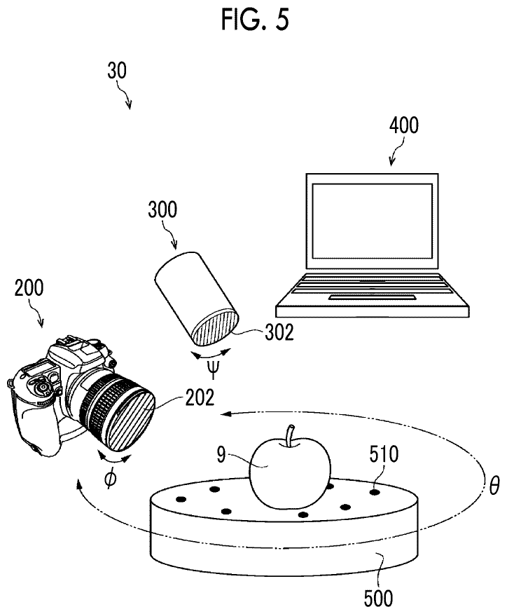

FIG. 5 is a diagram showing a configuration of the imaging system 30. The imaging system 30 includes a camera 200 (imaging device), an illumination device 300 (illumination device), and a controller 400. An object 9 to be imaged is disposed on an imaging table 500.

### Configuration of Camera

The camera 200 comprises at least an optical system such as a lens, an imaging element, and a processor that performs image processing and the like, and can capture an image of the object 9. A resolution of the image to be captured may be made changeable. As the imaging element, a photoelectric conversion element such as a complementary metal-oxide semiconductor (CMOS) or a charge-coupled device (CCD) can be used, and a color filter is disposed in each pixel of the imaging element to form a color pixel. The imaging element may be provided with a phase difference pixel. The phase difference pixel is configured by a pixel in which one side (for example, a left side or an upper side) of the pixel is shielded from light and a pixel in which the other side (for example, a right side or a lower side) of the pixel is shielded from light. The phase difference pixel may be provided with a microlens. By providing such a phase difference pixel two-dimensionally on a light-receiving surface of the imaging element, phase difference data can be acquired, and focus control can be performed by the phase difference data, and distance information (depth information) for the object (object 9 and the like) can be acquired.

The imaging system 30 may comprise distance information acquisition means other than such a phase difference pixel. As such distance information acquisition means, for example, a remote sensing technology using light called light detection and ranging (LiDAR) or light imaging and ranging is known. There are two types of LiDAR: a time-of-flight (ToF) method of emitting pulsed laser light; and a frequency modulated continuous wave (FMCW) method of continuously emitting frequency-modulated laser light.

In addition, the camera 200 is configured to be able to move around the object 9 and to be able to image the object 9 from a plurality of directions (a plurality of first directions and a plurality of second directions) in a case of moving around the object 9. The camera 200 comprises a rotatable polarization filter 202 (second polarizer). The polarization filter 202 may be a polarizer based on a wire grid type, a photonic crystal, or another principle. In addition, the polarization filter 202 may be attachable and detachable.

### Movement of Camera

In a case of imaging the entire object 9, the camera 200 moves around the object 9 (for example, 360° or more). In a case of imaging only a part of the object 9, the camera 200 moves in a specific range (a range smaller than 360°) of the object 9. The camera 200 can move around the object 9 by a user holding the camera 200 or by a moving object that supports the camera 200. The moving object is, for example, an arm or a crane attached to the imaging table 500. This arm is configured to be movable around the imaging table 500 by a motor or the like. In addition, in a case where the object 9 is large, the moving object may be a cart, a vehicle, or a drone. In the imaging system 30, the controller 400 may control the arm, the imaging table 500, or the like to change the imaging direction, or the user may move the arm, the imaging table 500, or the like to change the imaging direction.

### Plurality of Cameras Having Different Imaging Directions

In the imaging system 30, instead of moving the camera 200 by the arm, the cart, or the like, a plurality of cameras having different imaging directions may be provided. For example, the imaging system 30 may comprise a plurality of cameras 200 having different orientations in an up-down direction for one imaging direction (θ). Similarly, the imaging system 30 may comprise a plurality of cameras 200 having different imaging directions (θ). Similarly, the imaging system 30 may comprise a plurality of illumination devices 300 having different illumination directions (see a modification example described below).

### Polarized Imaging

The camera 200 is configured to be able to image the object 9 in the imaging direction at each position of the camera 200 while moving around the object 9. In addition, the camera 200 can acquire a plurality of polarized images obtained by imaging the object 9 in a state where rotation angles are different for one imaging direction via the polarization filter 202 whose rotation angle (polarization direction) can be set to any angle. This rotation angle is a rotation angle with respect to a reference angle of the polarization filter 202 in a case of imaging the object 9 with the camera 200. The imaging direction θ is an angle representing a relative positional relationship (horizontal direction) between the camera 200 and the object 9 with respect to reference positions of the camera 200 and the object 9 in a case of imaging the object 9 with the camera 200. The rotation angle of the polarization filter 202 can be changed manually directly by the user or automatically under the control of the controller 400.

The camera 200 is configured to be able to store the polarized image obtained by imaging the object 9 via the polarization filter 202. The camera 200 can acquire a plurality of polarized images obtained by imaging the object 9 in a state where the rotation angles of the polarization filter 202 are different (a state where the polarization directions are different) for the imaging direction of the object 9 manually by an operation from the user or automatically (under the control of the controller 400) while moving around the object 9.

### Configuration of Illumination Device

The illumination device 300 emits illumination light in a case of imaging the object 9. A type of a light source of the illumination device 300 is not particularly limited, but, for example, light-emitting diodes (LEDs) of a plurality of colors (red, blue, green, and the like) can be used. The illumination device 300 is preferably a device capable of not only turning illumination light on and off but also changing brightness and color tone (such as color temperature). In addition, the illumination device 300 comprises a rotatable polarization filter 302 (first polarizer) as with the camera 200, and can emit illumination light beams having different polarization directions. As a result, the imaging system 30 can image the object 9 irradiated with the illumination light beams having different polarization directions. A rotation angle of the polarization filter 302 can be changed manually directly by the user or automatically under the control of the controller 400. Hereinafter, the rotation angle of the polarization filter 302 is denoted by ψ.

The polarization filter 302 (polarizer) may be a polarizer based on a wire grid type, a photonic crystal, or another principle, as described above for the polarization filter 202. In addition, the polarization filter 302 may be attachable and detachable.

In addition, as described above for the camera 200, the illumination device 300 can be configured such that its position and/or irradiation direction can be changed using an arm, a crane, a cart, a vehicle, a drone, or the like. In this case, the controller 400 may control the arm, the cart, or the like to change the position and/or the irradiation direction of the illumination device 300, or the user may move the arm or the like to change the position and/or the irradiation direction. Alternatively, instead of changing the position or the irradiation direction of the illumination device 300, a plurality of illumination devices 300 having different positions or irradiation directions may be provided.

### Variation of Polarized Imaging

In the imaging system 30, the polarization filter may be provided only on one of the illumination device 300 or the camera 200, or the polarization filter may be omitted depending on conditions such as a feature of the object 9 (subject) and accuracy required for the three-dimensional model. In addition, the polarization filter may be disposed to be spaced from the illumination device 300 or the camera 200 instead of being directly provided on the illumination device 300 or the camera 200. For example, the polarization filter (polarizer) may be disposed between the illumination device 300 and the object 9 or between the camera 200 and the object 9.

### Controller

The controller 400 controls the imaging of the imaging system 30 and can transmit the captured image to the three-dimensional model generation device 20. The function of the controller 400 can be realized by installing software for imaging control, data transmission, and the like in a system such as a general-purpose computer, a computer for a specific purpose, and a workstation.

### Imaging Table

The imaging table 500 has a cylindrical shape with a flat top surface, and has a plurality of marks 510 on a placement surface (top surface). The mark 510 serves as an indicator of the imaging direction. In addition, a distance between two marks 510 (assumed to be known) serves as a size reference in a case of creating a three-dimensional model. The shape of the imaging table 500 is not limited as long as the object 9 can be placed on the imaging table 500, and the imaging table 500 may have a prismatic shape such as a rectangular parallelepiped instead of the cylindrical shape. The imaging table 500 is not essential in a case of considering a condition such as a size of the object 9 and a location where the object 9 is disposed. In a case where the imaging direction is changed by moving the camera 200 around the object 9, the imaging table 500 may be omitted. The position of the camera 200 may be fixed, and the imaging direction may be changed relatively by rotating the imaging table 500 under the control of the controller 400 and a motor (not shown).

The imaging table 500 may be transparent or translucent. By using the transparent or translucent imaging table 500, in a case of imaging the object 9 from below, it is possible to easily perform image processing (processing of extracting a subject region from the image and the like).

### BACKGROUND

In addition to the above configuration, the imaging system 30 may use a background in a case of imaging the object 9. The content of the background is not particularly limited, but a background that facilitates processing of the captured image (processing of extracting a subject region from the image and the like) is preferable. Specifically, a background of a single color such as a green screen or a blue screen, or a background having a pattern such as polka dots or a grid can be used. A combination of a single color and a pattern may be used. Such a background can be realized by using a display for showing the background, by projecting the background onto a screen, or by using a plate-shaped member or a wall in which the background is formed by printing or drawing.

### Configuration of Server Device

As described above with reference to FIG. 1, the system 1 comprises the server device 700, and the server device 700 includes the server device main body 710 and the database 720. The server device main body 710 can be configured by a general server computer, and the database 720 includes various recording media such as a magneto-optical recording device and a semiconductor memory, and a controller thereof, as with the recording device 180. The server device main body 710 controls communication with the three-dimensional model generation system 10, and the database 720 can record an image, conditions for capturing the image, a generated three-dimensional model, and the like for an object for which the three-dimensional model is to be generated. The three-dimensional model generation system 10 can acquire data from the server device 700 and can record data in the server device 700 in addition to or instead of the imaging system 30.

### Process of Generating Three-Dimensional Model

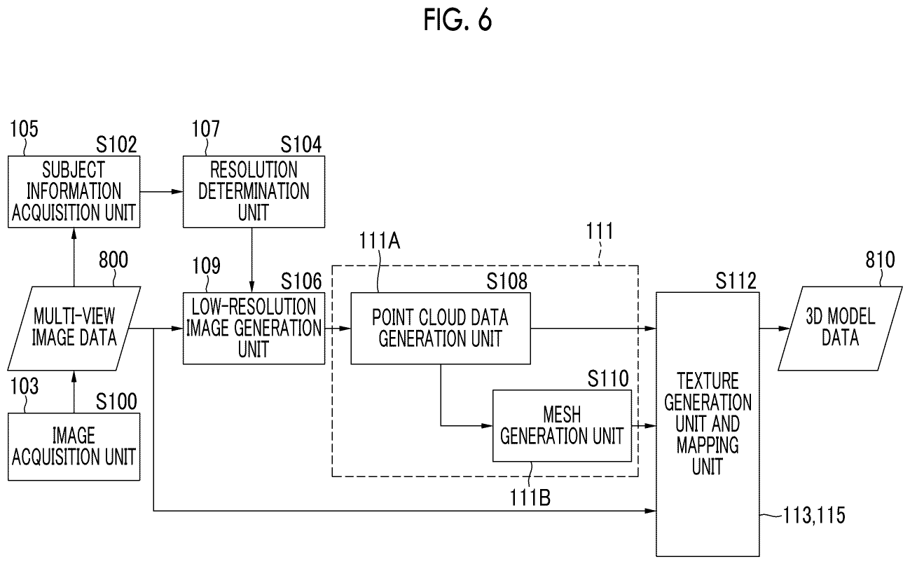

A process of generating a three-dimensional model in the system 1 having the above-described configuration will be described. FIG. 6 is a diagram showing an overall flow of the three-dimensional model generation.

### Acquisition of Multi-view Images

The three-dimensional model generation system 10 acquires multi-view images of an object (step S100). Specifically, the processor 100 (processing condition setting unit 101, image acquisition unit 103; processor) of the three-dimensional model generation device 20 acquires a plurality of first images obtained by imaging the object from a plurality of first directions at a first resolution. The expression “acquires a plurality of first images” means that the object may be newly imaged by the imaging system 30, or an image that has already been captured may be acquired from a recording device such as the recording device 180 or the server device 700 (database 720).

In capturing multi-view images, a plurality of images (multiple first images) having different imaging directions (a plurality of first directions) in the left-right direction and the up-down direction are acquired, but, in a case of using the above-mentioned imaging system 30, the imaging direction (θ) in the horizontal direction can be changed by rotating the imaging table 500. In addition, the imaging direction in the up-down direction may be changed by an arm, a crane, or the like, or may be changed by the user. In addition, imaging may be performed by using a plurality of cameras having different imaging directions without changing the imaging direction of each camera. The controller 400 can determine a pitch of the imaging direction (10 deg, 5 deg, 1 deg, and the like; may be a rotation pitch of the imaging table 500) depending on the quality required for the three-dimensional model. The controller 400 may determine the pitch in response to a command from the three-dimensional model generation device 20.

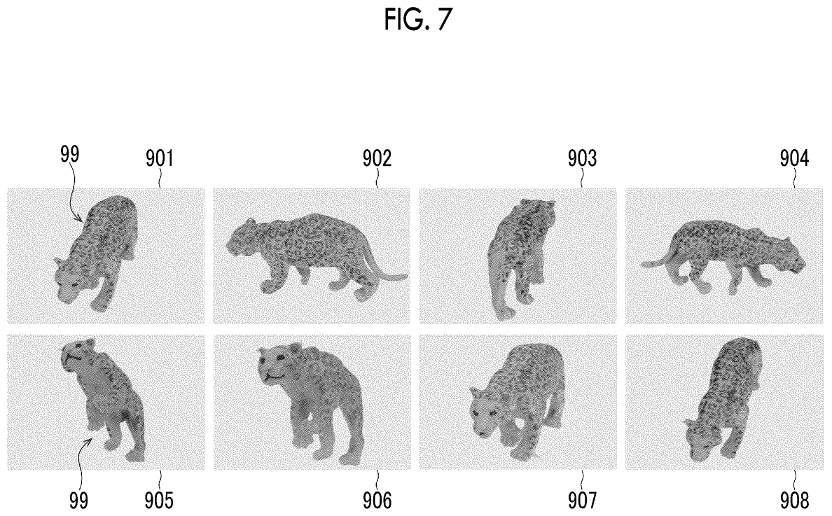

FIG. 7 is a diagram showing an example of the multi-view images (a plurality of first images). An upper part of FIG. 7 shows images 901 to 904 having different imaging directions (θ) in the horizontal direction, and a lower part of FIG. 7 shows images 905 to 908 having different imaging directions in the up-down direction. In all the images, the object 99 is a subject.

A resolution (first resolution) of the first image is a resolution used to generate a texture (surface information), and can be determined depending on the accuracy required for the texture. The processor 100 (processing condition setting unit 101 and the like) may determine the first resolution in response to an operation of the user, or may determine the first resolution without the operation of the user. The three-dimensional shape information can be generated by using images (a plurality of second images) having a second resolution lower than the first resolution, as will be described in detail below.

### Acquisition of Multi-View Images Using Polarized Imaging

In a case of imaging the object using the imaging system 30 having the above-described configuration, a plurality of polarized images (a plurality of first images) obtained by imaging the object in a plurality of polarization states in which polarization directions are different can be acquired. Specifically, in the polarized imaging, imaging is performed while changing the rotation angle (ψ in FIG. 5; corresponding to a first polarization direction) of the polarization filter 302 of the illumination device 300 and/or the rotation angle (φ in FIG. 5; corresponding to a second polarization direction) of the polarization filter 202 of the camera 200 in a range of, for example, 0 deg to 180 deg for one imaging direction (horizontal direction (θ in FIG. 5) and up-down direction), and this imaging is repeated while changing the imaging direction. Either ψ or φ may be changed or both may be changed. Pitches of ψ and φ can be determined depending on the quality or the accuracy required for the three-dimensional shape or the texture.

In the polarized imaging, it is preferable to acquire distance information and depth information in association with the multi-view images using means such as the phase difference pixel and LiDAR described above. The distance information or the depth information can be used for determining complexity of the three-dimensional shape of the object or for determining a degree of the low-resolution processing according to the complexity, as will be described in detail below.

### Low-Resolution Processing according to Subject Information

### Determination of Degree of Low-Resolution Processing According to Complexity of Three-Dimensional Shape

In the three-dimensional model generation system 10 according to the first embodiment, the degree of the low-resolution processing on the multi-view image can be determined according to the subject information (complexity of the three-dimensional shape of the object; object information), and the low-resolution processing can be performed at the determined degree. Specifically, the degree of the low-resolution processing is lowered as the complexity increases, so that an object having a complicated shape can be prevented from being lowered in resolution excessively, whereby it is possible to secure the quality of the three-dimensional model while reducing the processing load of the system. The three-dimensional shape information of the object can be generated by using the low-resolution images (a plurality of second images having the second resolution).

### Calculation of Complexity based on Feature Amount Extraction Processing

The processor 100 (subject information acquisition unit 105, resolution determination unit 107, and the like; processor) can perform the feature amount extraction processing on a region in which the object is shown in the above-described multi-view images, and calculate the complexity based on the feature amount obtained by the feature amount extraction processing (step S102 in FIG. 6). The processor may extract the “region in which the object is shown” by using artificial intelligence (AI; for example, can be constructed by using a neural network) that performs region extraction or segmentation, or may extract the region using general image processing (masking processing and the like) without using the AI.

### Calculation of Complexity by Edge Detection

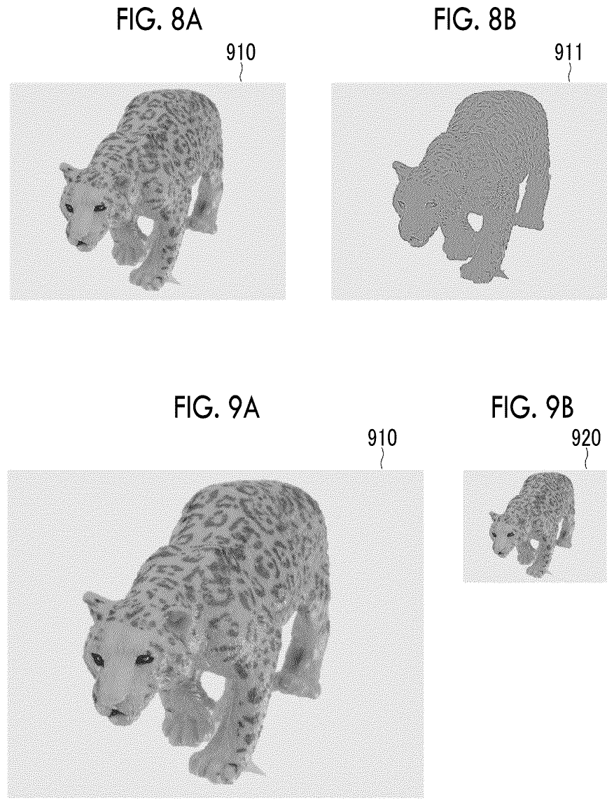

FIGS. 8A and 8B are diagrams showing an example of edge detection as an aspect of a method of calculating the complexity (feature amount) by analyzing the multi-view image. In the example of FIGS. 8A and 8B, the subject information acquisition unit 105 (processor 100; processor) performs edge detection on an original image 910 (image constituting the plurality of first images) using a high pass filter (HPF), and a result of calculating an edge degree (an example of the object information) for each pixel in a region in which the object 99 is shown is shown in an image 911. The edge degree is an aspect of the feature amount, and a high edge degree means that the complexity of the three-dimensional shape of the object is high. Examples of the type of the HPF include a Laplacian filter and a Sobel filter, but the present disclosure is not limited to these examples. The subject information acquisition unit 105 may detect the edge by using another filter or algorithm (for example, a Canny edge detector) or AI (including a detector constructed by a machine learning method). The AI that detects the edge may be AI that performs region extraction or segmentation, and can be constructed by, for example, a neural network such as a convolution neural network (CNN).

### Another Example of Calculation Method of Complexity

The method of determining the complexity of the three-dimensional shape of the object is not limited to the above-described edge detection. Another example of the calculation method of the complexity will be described below.

First, examples of another method of calculating the complexity by analyzing the images (a plurality of first images) of the object include a method of acquiring reflection information (reflection information regarding reflection of the object in the region in which the object is shown) from the images (a plurality of polarization images) obtained by the above-described polarized imaging and calculating the complexity based on the reflection information, and a method of acquiring intersection direction information (intersection direction information regarding a direction intersecting a surface of the object) from the images obtained by the polarized imaging. Here, a large or small change in the reflection information means that the three-dimensional shape of the object is complicated or simple. Similarly, a large or small change in the intersection direction information also means that the three-dimensional shape is complicated or simple. The “direction intersecting the surface of the object” is, for example, a normal direction, but is not limited to the normal direction in a strict sense, and need only be a direction intersecting the surface of the object. The reflection information or the intersection direction information is an example of the object information in the present invention.

The subject information acquisition unit 105 can also determine the complexity based on a depth map (distance information, depth information; object information) associated with the multi-view images, in addition to the above-described reflection information and intersection direction information. The subject information acquisition unit 105 can determine the complexity from, for example, analysis results (variance of the depth map and the like) of the depth in the subject region. As described above for the imaging system 30, the subject information acquisition unit 105 may acquire the depth map by using the output of the phase difference pixel of the camera 200, or may acquire the depth map by using LiDAR or the like. As described above for the reflection information and the intersection direction information, a large or small change in the depth in the region in which the object is shown means that the three-dimensional shape of the object is complicated or simple.

In the three-dimensional model generation system 10, the method of determining the complexity may be selected by the operation of the user or automatically without the operation. In addition, the subject information acquisition unit 105 and the output controller 117 (processor 100; processor) can output information indicating “complexity”, such as the edge detection result, the reflection information, the normal information, the distance information, and the depth information, to the display 22 and/or a recording device such as the recording device 180 in a form of a numerical value, a graph, an image, or the like. For example, it is possible to output an image (edge detection image, reflection information image, normal direction image (normal map), distance image, and the like) in which brightness and/or color changes depending on a degree of reflection, a normal direction, or a change in distance.

In the first embodiment, the complexity may be determined based on the input of the complexity information (information indicating the complexity of the three-dimensional shape of the object) from the user. In this case, the user may select the complexity classified into levels, such as “complexity is high, medium, or low” or “level of complexity is 1 to 10”.

### Resolution Determination

The resolution determination unit 107 (processor 100; processor) determines the degree of the low-resolution processing according to the complexity calculated by the above-described method (step S104). The resolution determination unit 107 may directly determine the resolution (the number of pixels) of the low-resolution image, or may determine a reduction ratio of the image (reducing the original image to ½ in both the vertical and horizontal directions).

The resolution determination unit 107 can set a smaller reduction ratio as the three-dimensional shape of the object is more complicated, and, in this case, the second resolution and the second image obtained as a result have a large size and a large number of pixels. On the contrary, in a case where the three-dimensional shape of the object is simple, the resolution determination unit 107 can set a large reduction ratio, and, in this case, the second resolution and the second image obtained as a result have a small size and a small number of pixels. For example, in a case where the multi-view image (first image) is 6,000×4,000 pixels, the resolution determination unit 107 can determine to output a second image of 4,500×3,000 pixels in a case where it is determined that “the shape of the object is complicated”, and can determine to output a second image of 1,500×1,000 pixels in a case where it is determined that “the shape of the object is simple”. In these examples, the resolution determination unit 107 can also determine “0.75 times the original image (example of small reduction ratio) in both the vertical and horizontal directions” and “0.25 times the original image (example of large reduction ratio) in both the vertical and horizontal directions”.

The resolution determination unit 107 may determine a lower limit value of the low-resolution processing in determining the degree of the low-resolution processing. For example, in a case where the determined number of pixels is equal to or less than a predetermined threshold value (for example, 1 MP), 1 MP can be set as the lower limit value in order to maintain the quality of the three-dimensional model.

In addition, the resolution determination unit 107 may change the degree of the low-resolution processing according to the imaging direction (left-right direction and up-down direction). For example, in a case where the shape of the object is simple in a case of being viewed (imaged) from one direction and the shape is complicated in a case of being viewed from another direction, the resolution determination unit 107 can change the degree of the low-resolution processing between the direction in which the shape is simple and the direction in which the shape is complicated, thereby reducing the time required for the generation of the three-dimensional shape information while maintaining the quality of the three-dimensional model.

As described above, in the invention of the present application, the term “low-resolution processing” means reducing the number of pixels of the second image relative to the number of pixels of the original image (first image) whether the resolution (the number of pixels) is determined directly or the reduction ratio is determined, whereby the time required for the generation of the three-dimensional shape information can be reduced while maintaining the quality of the three-dimensional model according to the complexity of the three-dimensional shape of the object.

### Generation of Low-Resolution Image

The low-resolution image generation unit 109 (processor 100; processor) generates a plurality of images (a plurality of second images) from the multi-view images using the resolution or the reduction ratio determined as described above (step S106). FIGS. 9A and 9B are diagrams showing an example of the low-resolution processing, and FIG. 9A shows an image 910 constituting the multi-view images, and FIG. 9B shows an image 920 obtained by resizing the original image 910. The resizing may be performed according to the reduction ratio, such as “reducing the original image to ½ in both the vertical and horizontal directions”, or may be performed according to the number of pixels, such as “generating an image of 1,500×1,000 pixels in a case where the original image is 6,000×4,000 pixels”. The low-resolution image generation unit 109 generates such a low-resolution image for each imaging direction.

### Generation of Three-Dimensional Model

The three-dimensional model can be generated by various methods, but a case of generating the three-dimensional model by mainly using a photogrammetry method will be described below.

### Generation of Three-Dimensional Shape Information

The three-dimensional shape information generation unit 111 (processor 100; processor) generates three-dimensional shape information of the object (object 99 in the examples of FIG. 7 to FIGS. 9A and 9B) by using the plurality of low-resolution images (a plurality of second images) (steps S108 and S110). The three-dimensional shape information generation unit 111 can be configured by a point cloud data generation unit 111A and a mesh generation unit 111B. Hereinafter, the generation of the three-dimensional shape information by the three-dimensional shape information generation unit 111 having such a configuration will be described.

### Generation of Point Cloud Data

The point cloud data generation unit 111A performs a process of analyzing the second image to generate three-dimensional point cloud data of feature points. Specifically, the point cloud data generation unit 111A extracts feature points from each image, and matches corresponding feature points between different images as corresponding points. The point cloud data generation unit 111A estimates camera parameters (for example, a fundamental matrix, an essential matrix, and internal parameters) of the camera 200, estimates the imaging position and orientation based on the estimated camera parameters, and obtains three-dimensional positions of the feature points of the object 99. Bundle adjustment is performed as necessary. Three-dimensional coordinates of the estimated feature points are combined to generate point cloud data (step S108). The point cloud data generation unit 111A can estimate the imaging position and orientation by a method such as structure from motion (SfM) and generate a (coarse) point cloud.

The mesh generation unit 111B generates a three-dimensional patch model (three-dimensional shape information) of the object 99 based on the three-dimensional point cloud data of the object 99 generated by the point cloud data generation unit 111A (step S110). Specifically, a patch (mesh) is generated from the generated three-dimensional point group, and the three-dimensional patch model is generated. Thus, the relief of the surface can be represented with a small number of points. The mesh generation unit 111B can generate a three-dimensional patch model (dense point cloud) by a method such as multi-view stereo (MVS).

In the example of FIG. 6, the mesh is generated from the three-dimensional point cloud, but the mesh generation unit 111B may further use the low-resolution image in a case of generating the mesh. In this case, a fine point cloud can be generated from the coarse point cloud and the low-resolution image.

In the first embodiment, a case of generating the three-dimensional shape information by using polygons and a mesh that is a collection of polygons has been described, but a “surface” may be generated as the three-dimensional shape information, and a texture may be mapped. In the mesh, the polygons collectively form one shape, whereas, in the surface, a single face forms one shape.

### Generation of Texture

The texture generation unit 113 (processor 100; processor) generates a texture (surface information corresponding to the three-dimensional shape information) from the generated three-dimensional point cloud (output of the point cloud data generation unit 111A), the mesh (output of the mesh generation unit 111B), and the original multi-view image (a plurality of first images having the first resolution) (step S112). The texture (surface information) includes at least information on a base color (color) of the object, and may further include information on at least one of a metalness or a roughness. The metalness can also be referred to as the metallicity of the object, and the roughness can also be referred to as the surface roughness of the object. The roughness may be replaced with glossiness. In addition, the texture may further include other information such as a normal and a displacement. The texture generation unit 113 and the output controller 117 (processor 100) can output the texture information as a UV map. The output may be recorded in a recording device such as the recording device 180 or the database 720, or may be displayed on a display device such as the display 22.

### Mapping of Texture

The mapping unit 115 (processor 100; processor) generates a three-dimensional model to which the texture is assigned by performing texture mapping on the three-dimensional patch model (three-dimensional mesh) generated by the mesh generation unit 111B (step S112). The mapping unit 115 assigns a realistic appearance of the object 99 to the three-dimensional patch model by mapping the texture onto the mesh.

### Example of Three-Dimensional Model Data

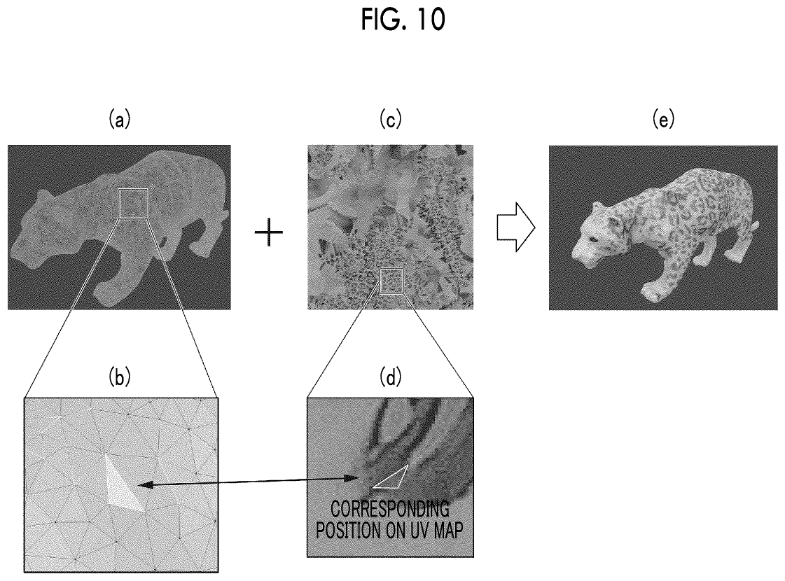

FIG. 10 is a diagram showing an example of three-dimensional model data. A portion (a) of FIG. 10 shows an example of mesh data 99A (a collection of polygons) output by the mesh generation unit 111B, and a portion (b) of FIG. 10 shows a state in which a part (region 99B) of the mesh data 99A is enlarged (a collection of triangular polygons). With respect to this, a portion (c) of FIG. 10 shows an example of a texture (UV map; surface information corresponding to the three-dimensional shape information) output by the texture generation unit 113, and a portion (d) of FIG. 10 shows a region in the UV map that corresponds to the polygon shown in the portion (b) of FIG. 10. The mapping unit 115 can map the texture shown in the portion (c) of FIG. 10 onto the mesh data shown in the portion (a) of FIG. 10, and generate a three-dimensional model to which the texture is assigned as shown in a portion (e) of FIG. 10.

### Output of Three-Dimensional Model Data

The mapping unit 115 and the output controller 117 (processor 100; processor) can record the generated three-dimensional model data in the recording device 180 or the server device 700 (database 720), or can display the generated three-dimensional model data on the display 22. This three-dimensional model data can be used in various types of video (such as television programs, movies, moving images distributed over a network, games, virtual spaces, or images displayed in measurement or surveying systems, but not limited to this), or can be output via an input/output interface to a 3D printer (not shown).

As described above, with the three-dimensional model generation device, the three-dimensional model generation system, and the operation method of the three-dimensional model generation device according to the first embodiment, in generating the three-dimensional model, by using an image having a high resolution for texture generation and using an image having a lower resolution than that used for the texture generation for shape data generation, the processing load can be reduced while maintaining the quality of the three-dimensional data.

### Modification Example

### Modification Example of Three-Dimensional Model Generation Method

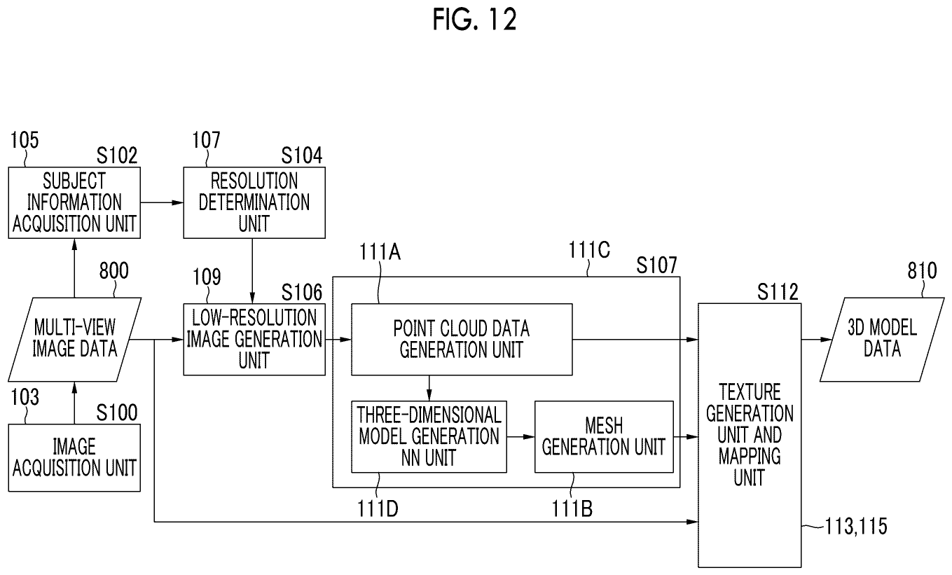

FIG. 12 is an example of a case where a three-dimensional shape information generation unit 111C generates three-dimensional shape information (step S107), and the texture generation unit 113 and the mapping unit 115 perform the generation of the texture and the mapping, respectively. In the three-dimensional shape information generation unit 111C, a three-dimensional model generation NN unit 111D (NN: Neural Network) can be realized by using AI, for example, a method of neural radiance fields (NeRF) or 3D Gaussian Splatting (3DGS).

NeRF is a technique of reconstructing a three-dimensional scene from two-dimensional images (multi-view images) by using a neural network. Specifically, NeRF is a method of, by using a neural network, outputting an image at any viewpoint position and viewpoint direction (input) in a three-dimensional space in terms of radiance (corresponding to RGB information) and volume density (corresponding to transparency). In NeRF, camera parameters (position or angle) are estimated from a plurality of two-dimensional images and used for learning (make a relationship between input and output approximate that of learning images). Specifically, NeRF receives point coordinates and a line-of-sight direction in the three-dimensional space as input, and outputs a color (RGB value) and a density of that point. NeRF has advantages such as an ability to generate an image at any viewpoint and an ability to generate a three-dimensional model even with a relatively small number of images. In a case where NeRF is used in the three-dimensional model generation NN unit 111D, it is desirable to use the imaging position and orientation of the camera estimated by the point cloud data generation unit 111A and the low-resolution image generated by the low-resolution image generation unit 109.

On the other hand, 3DGS is a method of constructing a three-dimensional space by superimposing an elliptical distribution (composed of position information, variation, transparency, and color parameters) called “3D Gaussian” on a three-dimensional point cloud without using polygons. In 3DGS, the above parameters are learned by a neural network such that the appearance at each viewpoint approaches a ground truth image. 3DGS has advantages such as an ability to generate an image at any viewpoint in a short time and an ability to generate a three-dimensional model with the same level of accuracy as NeRF.

In the aspect shown in FIG. 12, as in the first embodiment, a low-resolution image is generated based on the subject information (steps S102 to S106), and a three-dimensional point cloud and mesh are generated by using the above-described AI (step S107). A three-dimensional model generator constructed by using a machine learning method may be used. These AIs can also execute the texture generation and the mapping by using the original multi-view images (a plurality of first images having the first resolution) as in the first embodiment (step S112).

### Modification Example of Imaging System

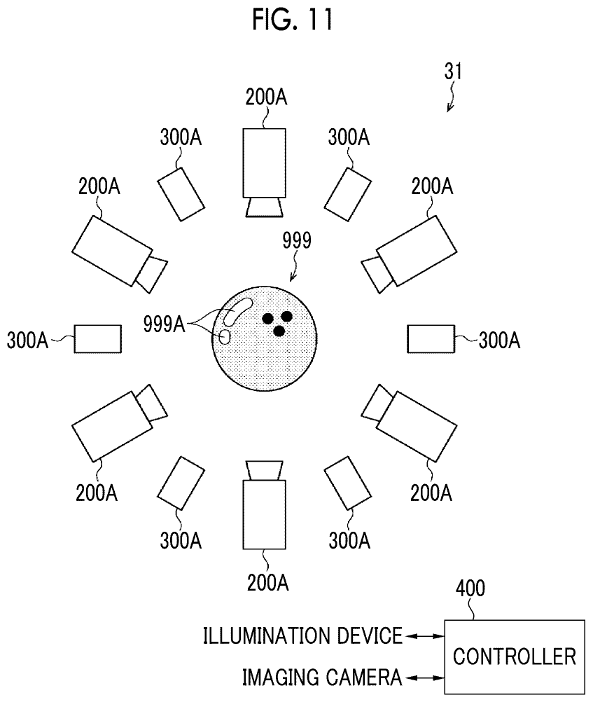

A modification example of the imaging system in the first embodiment will be described. FIG. 11 is a diagram showing a configuration of an imaging system 31 according to the modification example, and the imaging system 31 comprises a plurality of illumination devices 300A and cameras 200A, and a controller 400. Here, a subject 999 is a bowling ball, and a reflection region 999A is generated.

In the imaging system 30 described above, the illumination direction and the imaging direction can be changed by using the imaging table 500, but, in the imaging system 31 according to the modification example, a plurality of illumination devices 300A (illumination devices) and cameras 200A (imaging devices) are provided, and by sequentially switching the illumination devices 300A and/or the cameras 200A used for the imaging, a plurality of images having different imaging directions can be captured. In FIG. 11, a state in which the plurality of illumination devices 300A and cameras 200A are disposed in either the horizontal direction or the up-down direction is shown, but the plurality of illumination devices 300A and cameras 200A may be disposed in both the horizontal direction and the up-down direction, and the multi-view images may be captured without moving the illumination devices or the cameras.

The illumination device 300A comprises a polarization filter (not shown) as with the illumination device 300 of the imaging system 30, and can emit illumination light beams having different polarization directions by rotating the polarization filter. In addition, the camera 200A comprises a polarization filter (not shown) as with the camera 200 of the imaging system 30, and can capture images having different polarization directions by rotating the polarization filter.

Other configurations of the imaging system 31 are the same as those of the imaging system 30. The camera 200A may comprise a phase difference pixel as with the camera 200, or may comprise distance information acquisition means such as LiDAR.

### Second Embodiment

In the first embodiment described above, the degree of the low-resolution processing (reduction ratio, number of pixels, and the like) is determined according to the complexity of the three-dimensional shape of the object, and the original multi-view image is subjected to the low-resolution processing at a determined degree to acquire an image (second image) for generating the three-dimensional shape information. However, in the present invention, an image for generating the three-dimensional shape information may be acquired by performing imaging (separate imaging) different from the imaging for acquiring the original multi-view image. The acquisition by such imaging is also included in “acquisition of a plurality of second images” in the present invention.

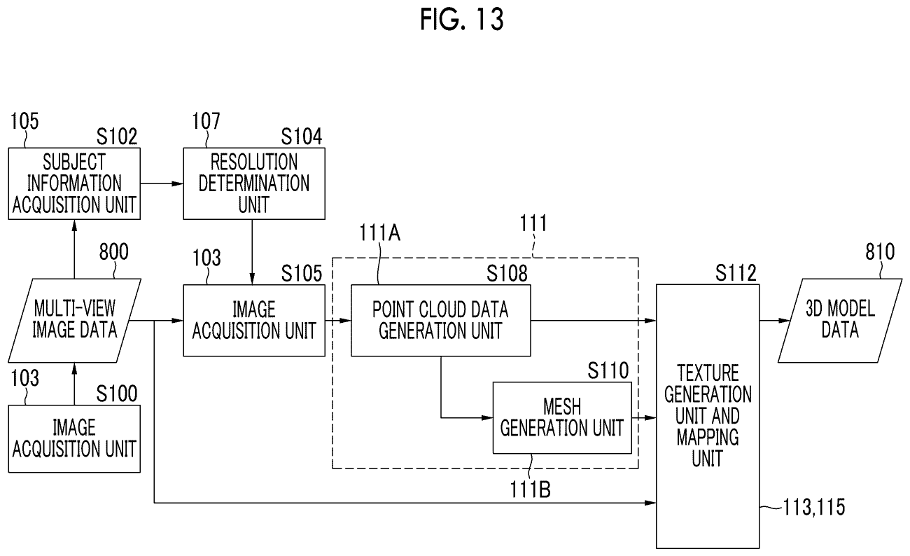

FIG. 13 is a diagram showing processing in a second embodiment. In the second embodiment, the same system configuration (see FIGS. 1 to 5 and 11; including the modification example) as that of the first embodiment can be adopted. In the second embodiment, in a case where the degree of the low-resolution processing is determined in step S104, the image acquisition unit 103 (processor 100; processor) captures images (a plurality of second images) at the determined degree (step S105). The imaging may be performed by using the imaging system 30 (see FIG. 5) or the imaging system 31 (see FIG. 11). Polarized imaging may be performed by using the polarization filter.

It is preferable that the second images be captured from the same position and the same direction as the multi-view images (first images), but it is possible to generate the three-dimensional model even in a case where the imaging position or the direction is different. In addition, the second images may be captured at positions and/or directions that are more sparsely sampled than those for capturing the multi-view images (first images). For example, in a case where the imaging direction is changed at an interval of 1 deg in capturing the multi-view images, the second images may be captured at an interval of 5 deg, 10 deg, or the like. The subject information acquisition unit 105, the resolution determination unit 107, and the image acquisition unit 103 (processor 100; processor) can determine a degree of sparse sampling according to the complexity of the three-dimensional shape of the object. In addition, the degree of the sparse sampling may be different depending on the imaging position or the direction. For example, the degree of the sparse sampling can be increased at the imaging position and the direction where the object has a simple shape, and the degree of the sparse sampling can be decreased at the imaging position and the direction where the object has a complicated shape.

The embodiments and modification examples of the present invention have been described above, but the present invention is not limited to the aspects, and various modifications can be made.

### EXPLANATION OF REFERENCES

1: system
9: object
10: three-dimensional model generation system
20: three-dimensional model generation device
22: display
30: imaging system
31: imaging system
99: object
99A: mesh data
99B: region
100: processor
101: processing condition setting unit
103: image acquisition unit
105: subject information acquisition unit
107: resolution determination unit
109: low-resolution image generation unit
110: processor
111: three-dimensional shape information generation unit
111A: point cloud data generation unit
111B: mesh generation unit
111C: three-dimensional shape information generation unit
111D: three-dimensional model generation NN unit
113: texture generation unit
115: mapping unit
117: output controller
140: operation unit
150: speaker
170: input/output interface
180: recording device
182: multi-view image
183: low-resolution image
184: subject information
185: three-dimensional shape information
186: texture information
190: bus
200: camera
200A: camera
202: polarization filter
300: illumination device
300A: illumination device
302: polarization filter
400: controller
500: imaging table
510: mark
700: server device
710: server device main body
720: database
901: image
902: image
903: image
904: image
905: image
906: image
907: image
908: image
910: image
911: image
920: image
999: subject
999A: reflection region

What is claimed is:

1. A three-dimensional model generation device comprising:
a processor,
wherein the processor is configured to
acquire a plurality of first images having a first resolution with respect to a plurality of first directions of an object,
acquire a plurality of second images having a second resolution lower than the first resolution with respect to a plurality of second directions of the object,
generate three-dimensional shape information of the object by using the plurality of second images,
generate surface information of the object corresponding to the three-dimensional shape information by using the plurality of first images, and
generate a three-dimensional model of the object by mapping the surface information onto a three-dimensional shape indicated by the three-dimensional shape information.

2. The three-dimensional model generation device according to claim 1,
wherein the processor is configured to generate and acquire the plurality of second images by subjecting the plurality of first images to low-resolution processing.

3. The three-dimensional model generation device according to claim 2,
wherein the processor is configured to determine a degree of the low-resolution processing depending on complexity of the three-dimensional shape of the object, and perform the low-resolution processing at the determined degree.

4. The three-dimensional model generation device according to claim 3,
wherein the processor is configured to lower the degree of the low-resolution processing as the complexity increases.

5. The three-dimensional model generation device according to claim 3,
wherein the processor is configured to calculate the complexity based on object information that is information on the object.

6. The three-dimensional model generation device according to claim 3,
wherein the processor is configured to calculate the complexity by analyzing the plurality of first images, and determine the degree according to the calculated complexity.

7. The three-dimensional model generation device according to claim 3,
wherein the processor is configured to perform feature amount extraction processing on at least a region in which the object is present in the plurality of first images, and calculate the complexity based on a feature amount obtained by the feature amount extraction processing.

8. The three-dimensional model generation device according to claim 7,
wherein the processor is configured to calculate the complexity by using, as the feature amount, an edge degree obtained by edge detection in the region.

9. The three-dimensional model generation device according to claim 3,
wherein the processor is configured to
acquire a plurality of polarized images obtained by imaging the object in a plurality of polarization states in which polarization directions are different,
acquire reflection information regarding reflection of the object based on the plurality of polarized images, and
calculate the complexity based on the reflection information.

10. The three-dimensional model generation device according to claim 9,
wherein the processor is configured to acquire, as the plurality of polarized images, a plurality of images obtained by imaging the object in a plurality of polarization states in which first polarization directions determined by rotation angles of a first polarizer provided in an illumination device are different.

11. The three-dimensional model generation device according to claim 9,
wherein the processor is configured to acquire, as the plurality of polarized images, a plurality of images obtained by imaging the object in a plurality of polarization states in which second polarization directions determined by rotation angles of a second polarizer provided in an imaging device are different.

12. The three-dimensional model generation device according to claim 3,
wherein the processor is configured to
acquire a plurality of polarized images obtained by imaging the object in a plurality of polarization states in which polarization directions are different,
acquire intersection direction information regarding a direction intersecting a surface of the object based on the plurality of polarized images, and
calculate the complexity based on the intersection direction information.

13. The three-dimensional model generation device according to claim 12,
wherein the processor is configured to acquire, as the plurality of polarized images, a plurality of images obtained by imaging the object in a plurality of polarization states in which first polarization directions determined by rotation angles of a first polarizer provided in an illumination device are different.

14. The three-dimensional model generation device according to claim 12,
wherein the processor is configured to acquire, as the plurality of polarized images, a plurality of images obtained by imaging the object in a plurality of polarization states in which second polarization directions determined by rotation angles of a second polarizer provided in an imaging device are different.

15. The three-dimensional model generation device according to claim 3,
wherein the processor is configured to
acquire distance information for the object associated with the plurality of first images, and
calculate the complexity based on the distance information.

16. The three-dimensional model generation device according to claim 1,
wherein the processor is configured to receive input of complexity information indicating complexity of the three-dimensional shape of the object from a user, and determine the second resolution based on the complexity information.

17. The three-dimensional model generation device according to claim 1,
wherein the surface information includes at least information on a base color of the object.

18. A three-dimensional model generation system comprising:
the three-dimensional model generation device according to claim 1; and
an imaging device that images the object to acquire the plurality of first images.

19. The three-dimensional model generation system according to claim 18, further comprising:
an illumination device that is capable of emitting illumination light beams having different polarization directions,
wherein the imaging device images the object irradiated with the illumination light beams having different polarization directions to acquire the plurality of first images and/or the plurality of second images.

20. An operation method of a three-dimensional model generation device including a processor, the operation method comprising:
causing the processor to execute
acquiring a plurality of first images having a first resolution with respect to a plurality of first directions of an object,
acquiring a plurality of second images having a second resolution lower than the first resolution with respect to a plurality of second directions of the object,
generating three-dimensional shape information of the object by using the plurality of second images,
generating surface information of the object corresponding to the three-dimensional shape information by using the plurality of first images, and
generating a three-dimensional model of the object by mapping the surface information onto a three-dimensional shape indicated by the three-dimensional shape information.
